(19) United States
(12) Patent Application Publication
(10) Pub. No.: US 2025/0023304 A1
(43) Pub. Date: Jan. 16, 2025

(54) ELECTRICAL CONNECTOR

(71) Applicant: MITSUMI ELECTRIC CO., LTD., Tokyo (JP)

(72) Inventors: Takahiro AKAIKE, Tokyo (JP); Hiroyuki SADOHARA, Tokyo (JP); Takashi KAWASAKI, Tokyo (JP)

(21) Appl. No.: 18/762,082

(22) Filed: Jul. 2, 2024

(30) Foreign Application Priority Data
Jul. 13, 2023 (JP) 2023-115106

(51) Int. Cl. H01R 24/40; H01R 13/502

(52) U.S. Cl. CPC H01R 24/40; H01R 13/502

(57) ABSTRACT

An electrical connector includes at least one lower receptacle assembly, at least one upper receptacle assembly located on the upper side of the at least one lower receptacle assembly, at least one shield member located between the at least one lower receptacle assembly and the at least one upper receptacle assembly, and a metal shell for holding the at least one lower receptacle assembly, the at least one upper receptacle assembly, and the at least one shield member. The at least one shield member engages with a cylindrical portion of an upper housing of the at least one upper receptacle assembly.

### CROSS-REFERENCE TO RELATED APPLICATION

The present application claims priority from Japanese Patent Application No. 2023-115106, filed Jul. 13, 2023. The entire contents of the above-listed application are hereby incorporated by reference for all purposes.

### TECHNICAL FIELD

The present disclosure generally relates to electrical connectors, in particular to an electrical connector used for providing a coaxial connection with a coaxial cable.

### BACKGROUND ART

In order to provide an electrical connection between an electronic device and another electronic device through a cable, a combination of a receptacle connector and a plug connector has been widely used. Further, an amount of data transmitted from the electronic device to the other electronic device through the cable has increased as processing capacities of electronic devices have been improved in recent years. In order to transmit a large amount of data in a short time, it is necessary to transmit a high frequency signal through the cable. Thus, there are needs of improving signal transmission characteristics of the cable, particularly, signal transmission characteristics of the cable in a high frequency band. In order to address such needs, a coaxial cable having high signal transmission characteristics in the high frequency band has been widely used. As is well known, the coaxial cable has a coaxial structure in which a core wire for transmitting a signal, an inner insulator layer covering the core wire, an outer conductor layer (a braid layer) covering the inner insulator layer and an outer insulator layer covering the outer conductor layer are concentrically arranged.

In order to provide a coaxial connection with the above-mentioned coaxial cable, there has been widely used an electrical connector including a contact pin to be electrically connected to the core wire of the coaxial cable, an insulating housing for holding the contact pin therein, and a metal shell covering the housing from the outer side. For example, patent document 1 discloses a receptacle type electrical connector 500 shown in FIG. 1. FIG. 1 is a cross-sectional view showing a configuration of the electrical connector 500.

The electrical connector 500 includes a receptacle assembly 530 constituted of a contact pin 510 and an insulating housing 520 for holding the contact pin 510 therein, a metal shell 540 for holding the receptacle assembly 530 so as to cover the receptacle assembly 530 from the outer side, and an insulating cover 550 for covering the shell 540 from the outer side. The electrical connector 500 should be mounted on a circuit board of an arbitrary device. At this time, a terminal portion 511 of the contact pin 510 and a ground terminal 541 of the shell 540 are respectively connected to corresponding terminals. Further, a plug type mating connector connected to an end portion of the coaxial cable is inserted into the electrical connector 500 from a tip side (a left side in FIG. 1), and thereby the electrical connector 500 and the mating connector are coupled with each other. When the electrical connector 500 and the mating connector are coupled with each other, a contact portion 512 of the contact pin 510 contacts with a contact pin of the mating connector and a cylindrical portion 542 of the shell 540 contacts with a metal outer contact of the mating connector. As a result, it is possible to provide the coaxial connection between the circuit board on which the electrical connector 500 is mounted and the coaxial cable to which the mating connector is connected through the electrical connector 500 and the mating connector.

In the electrical connector 500, when the mating connector is inserted into the electrical connector 500 from the tip side, the mating connector contacts with a horizontally extending portion 521 of the housing 520, and thus external force toward a base side (a right side in FIG. 1) is applied to the receptacle assembly 530. At this time, the receptacle assembly 530 is shifted toward the base side in the shell 540. This shift makes a position of the contact pin 510 in an insertion hole 546 of the shell 540 unstable. As a result, a contact reliability of the electrical connector 500 is deteriorated.

In order to address this problem, the patent document 1 discloses a configuration shown in FIG. 2, in which a pair of engagement protrusions 544 are respectively provided on inner surfaces 543 of a pair of side walls of the shell 540. By respectively engaging the pair of engagement protrusions 544 of the shell 540 with outer surfaces of a downwardly extending portion 522 of the housing 520, it is possible to improve holding force for holding the receptacle assembly 530 in the shell 540 to prevent the above-mentioned shift of the receptacle assembly 530 in the shell 540.

On the other hand, depending on specifications of a device in which the electrical connector 500 is used, there is a case that the number of ports of the electrical connector 500, that is, the number of coaxial cables electrically connected to the circuit board through the electrical connector 500 and the mating connector should be 2 or more (see a configuration of an electrical connector of patent document 2). For example, as shown in FIG. 3, an electrical connector 500 including more than two receptacle assemblies 530 (in the illustrated example, six receptacle assemblies 530) may be used. In this case, the shell 540 includes six cylindrical portions 542 respectively corresponding to the six receptacle assemblies 530. The six receptacle assemblies 530 are held by the shell 540 so as to be exposed in the cover 550 and form upper and lower two lines. Hereinafter, each of the three receptacle assemblies 530 held by the shell 540 and exposed in the cover 550 so as to form the lower line will be referred to as a lower receptacle assembly 530L. Each of the three receptacle assemblies 530 held by the shell 540 and exposed in the cover 550 so as to form the upper line will be referred to as an upper receptacle assembly 530U.

FIG. 4 shows a cross-sectional perspective view of the shell 540 of the above-mentioned electrical connector 500. The shell 540 is obtained by a molding method using metallic material. When the shell 540 is molded, a columnar mold for forming an insertion hole 546 for the upper receptacle assembly 530U needs to be inserted into a frame mold corresponding to an outer shape of the shell 540 from a direction indicated by a dotted arrow A in FIG. 4. Further, a columnar mold for forming an insertion hole 546 for the lower receptacle assembly 530L needs to be inserted into the frame mold from a direction indicated by a dotted arrow B in FIG. 4. Furthermore, in order to form the engagement protrusions 544 on the inner surfaces 543 of the pair of side walls of the shell 540, it is necessary to insert a mold for the engagement protrusions 544 into the frame mold from a direction indicated by a dotted arrow C in FIG. 4 (a lower side).

In order to improve the holding force for holding the upper receptacle assembly 530U in the shell 540, it is required to achieve the engagement between the above-mentioned engagement protrusions 544 of the shell 540 and the outer surfaces of the downwardly extending portion 522 of the housing 520 at a position as close as possible to the horizontally extending portion 521 of the housing 520 to which the external force is applied. Accordingly, as shown by a dotted line in FIG. 4, it is required to provide the engagement protrusions 544 on upper inner surfaces 545 of the shell 540 facing upper portions of the downwardly extending portion 522 of the housing 520. However, since the columnar mold is inserted into the frame mold from the direction of the dotted arrow B in FIG. 4 during the molding of the shell 540 as described above, it is impossible to reach the mold for the engagement protrusions 544 inserted from the lower side to the upper inner surfaces 545. Thus, it is impossible to form the engagement protrusions 544 on the upper inner surfaces 545. Therefore, in the case where the electrical connector 500 is configured to include one or more upper receptacle assemblies 530U and one or more lower receptacle assemblies 530L, it becomes impossible to prevent the shift of the one or more upper receptacle assemblies 530U in the shell 540. Thus, there is a problem that a connection reliability of the electrical connector 500 is deteriorated.

### RELATED ART DOCUMENTS

### Patent Documents

Patent document 1: JP 2023-103602
Patent document 2: JP 2022-149019A

### SUMMARY OF THE INVENTION

### Problem to be Solved by the Invention

The present disclosure has been made in view of the problem of the conventional art mentioned above. Accordingly, it is an object of the present disclosure to provide an electrical connector which includes an upper receptacle assembly and a lower receptacle assembly and can prevent a shift of the upper receptacle assembly in the shell.

### Means for Solving the Problems

The above object is achieved by the present disclosure defined by the following (1).

(1) An electrical connector, comprising:
at least one lower receptacle assembly;
at least one upper receptacle assembly located on an upper side of the at least one lower receptacle assembly;
at least one shield member located between the at least one lower receptacle assembly and the at least one upper receptacle assembly; and
a metal shell for holding the at least one lower receptacle assembly, the at least one upper receptacle assembly, and the at least one shield member,
wherein each of the at least one lower receptacle assembly and the at least one upper receptacle assembly includes at least one contact pin and an insulating housing for holding the at least one contact pin therein,
wherein the at least one contact pin includes a horizontally extending portion linearly extending in a front-rear direction and a downwardly extending portion extending from a base end portion of the horizontally extending portion toward a lower side,
wherein the housing includes a cylindrical portion which linearly extends in the front-rear direction and in which the horizontally extending portion of the at least one contact pin is located, and a downwardly extending portion which extends from a base end portion of the cylindrical portion toward the lower side and in which the downwardly extending portion of the at least one contact pin is located,
wherein the at least one shield member is held by the shell so that the at least one shield member is located between the downwardly extending portion of the at least one contact pin of the at least one lower receptacle assembly and the downwardly extending portion of the at least one contact pin of the at least one upper receptacle assembly, and
wherein the at least one shield member engages with the cylindrical portion of the housing of the at least one upper receptacle assembly.

### Effect of the Invention

In the electrical connector of the present disclosure, the shield member press-fitted into the shell engages with the cylindrical portion of the housing of the upper receptacle assembly. As a result, it is possible to prevent the shift of the upper receptacle assembly in the shell, thereby improving the contact reliability of the electrical connector.

### BRIEF DESCRIPTION OF THE FIGURES

FIG. 1 is a cross-sectional view of a conventional electrical connector.

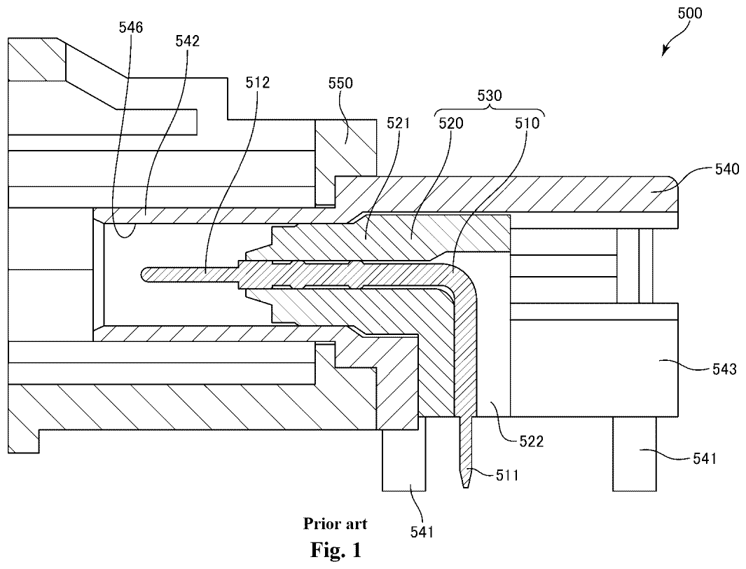

FIG. 2 is a perspective view of a shell of the electrical connector shown in FIG. 1.

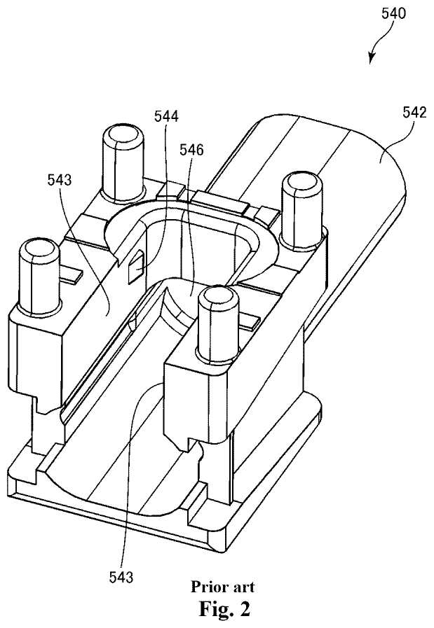

FIG. 3 is a perspective view showing an example of an electrical connector including a plurality of receptacle assemblies.

FIG. 4 is a cross-sectional perspective view of a shell of the electrical connector shown in FIG. 3.

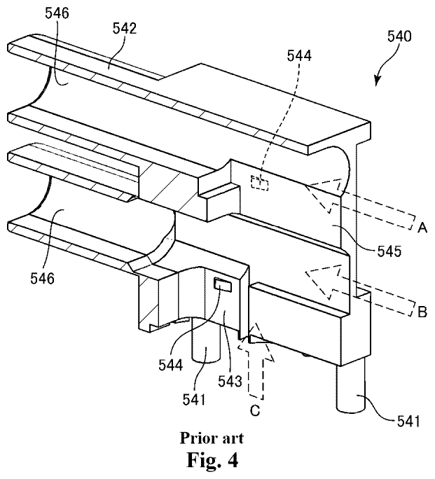

FIG. 5 is a perspective view showing an electrical connector of the present disclosure.

FIG. 6 is a perspective view of the electrical connector of the present disclosure viewed from another angle.

FIG. 7 is a cross-sectional view of the electric connector shown in FIG. 5 along a YZ plane including contact pins.

FIG. 8 is a cross-sectional perspective view of the electric connector shown in FIG. 5 along the YZ plane including the contact pins.

FIG. 9 is an exploded perspective view of the electrical connector shown in FIG. 5.

FIG. 10 is an exploded perspective view of an upper receptacle assembly of the electrical connector shown in FIG. 5.

FIG. 11 is a perspective view of a housing of the upper receptacle assembly shown in FIG. 10 viewed from another angle.

FIG. 12 is an exploded perspective view of a lower receptacle assembly of the electrical connector shown in FIG. 5.

FIG. 13 is a perspective view of a housing of the lower receptacle assembly shown in FIG. 12 viewed from another angle.

FIG. 14 is a perspective view of a shell shown in FIG. 9 viewed from another angle.

FIG. 15 is a cross-sectional perspective view of the shell shown in FIG. 9.

FIG. 16 is a perspective view of a cover shown in FIG. 9 viewed from another angle.

### DETAILED DESCRIPTION

Hereinafter, description will be given to an electrical connector of the present disclosure based on a preferred embodiment shown in the accompanying drawings. In this regard, the drawings referenced in the following description are schematic views prepared for explaining the present disclosure. A dimension (such as a length, a width and a thickness) of each component shown in the drawings is not necessarily identical to an actual dimension. Further, the same reference numbers are used throughout the drawings to refer to the same or like elements. In the following description, a positive direction of the Z axis in each figure may be referred to as a “tip side” or a “front side”, a negative direction of the Z axis in each figure may be referred to as a “base side” or a “rear side”, a positive direction of the Y axis in each figure may be referred to as an “upper side”, a negative direction of the Y axis in each figure may be referred to as a “lower side”, a positive direction of the X axis in each figure may be referred to as a “near side”, and a negative direction of the X axis may be referred to as a “far side” in each figure. In addition, the Z direction may be referred to as a “front-rear direction”, the Y direction may be referred to as a “height direction”, and the X direction may be referred to as a “width direction”.

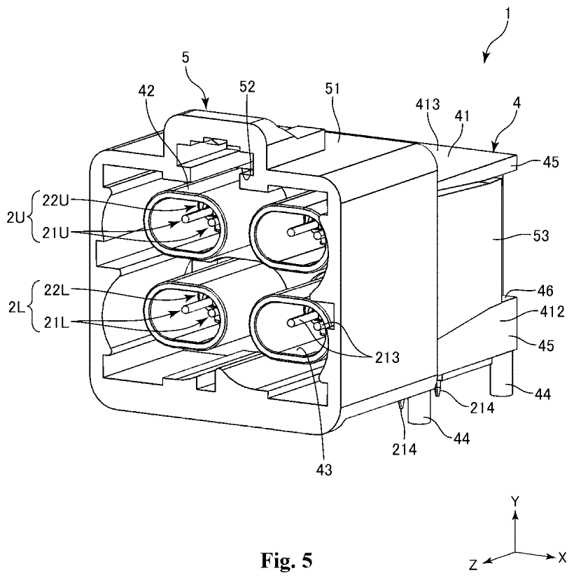

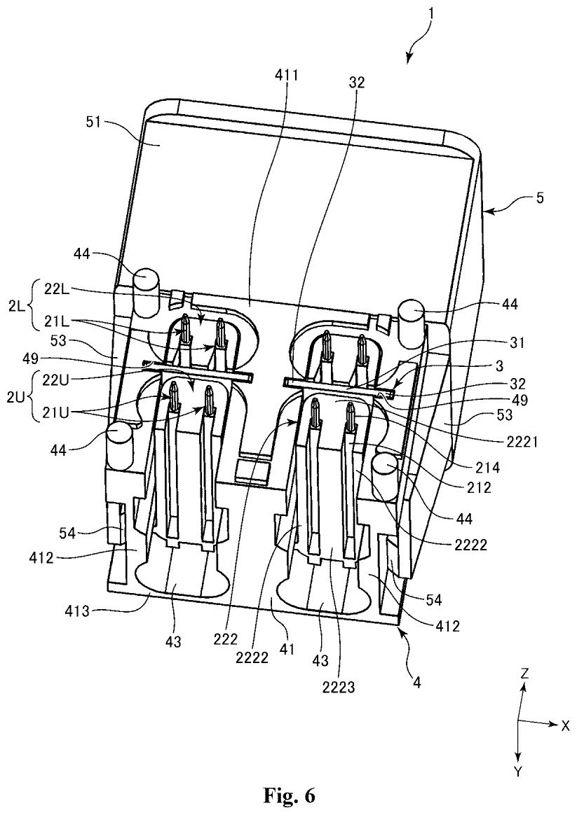

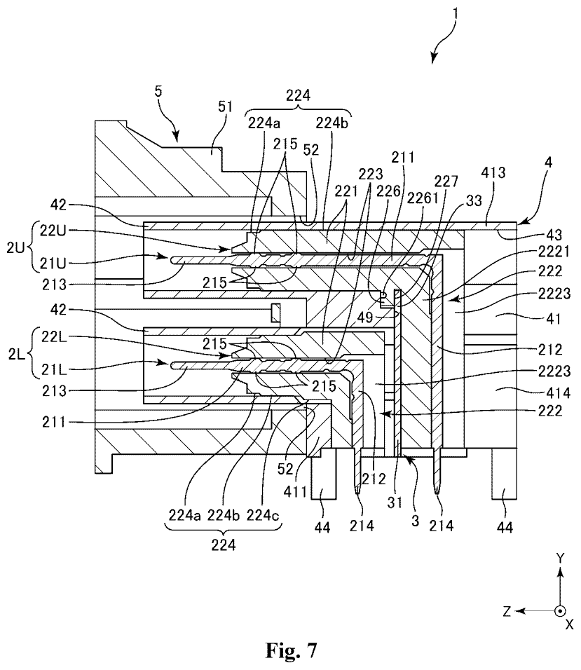

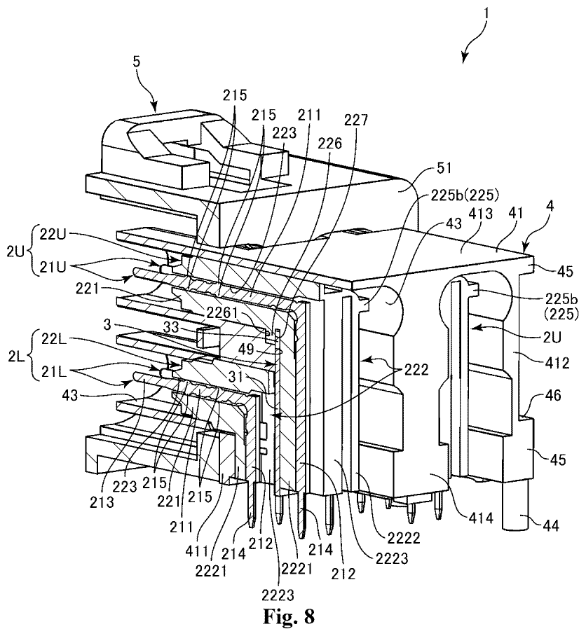

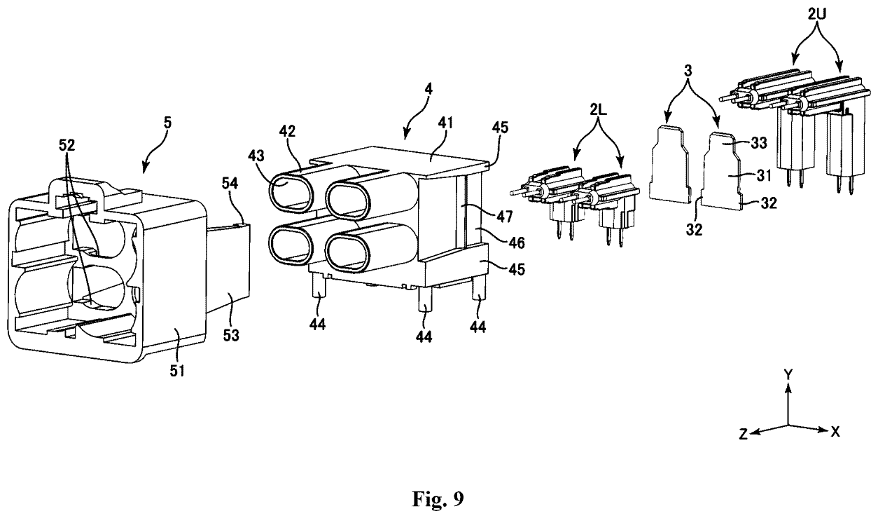

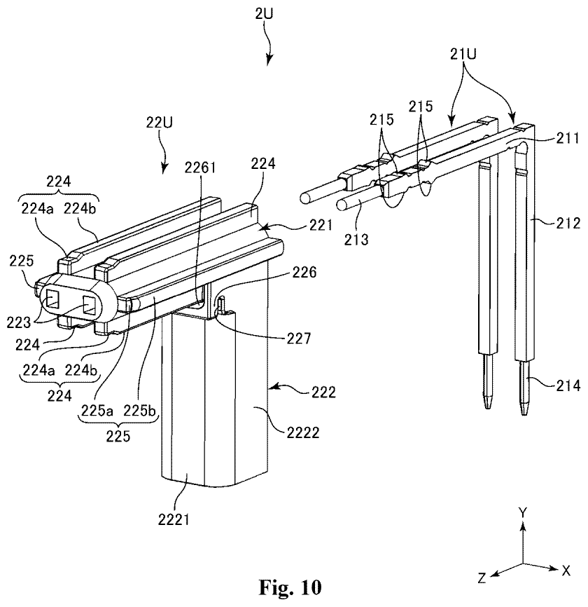

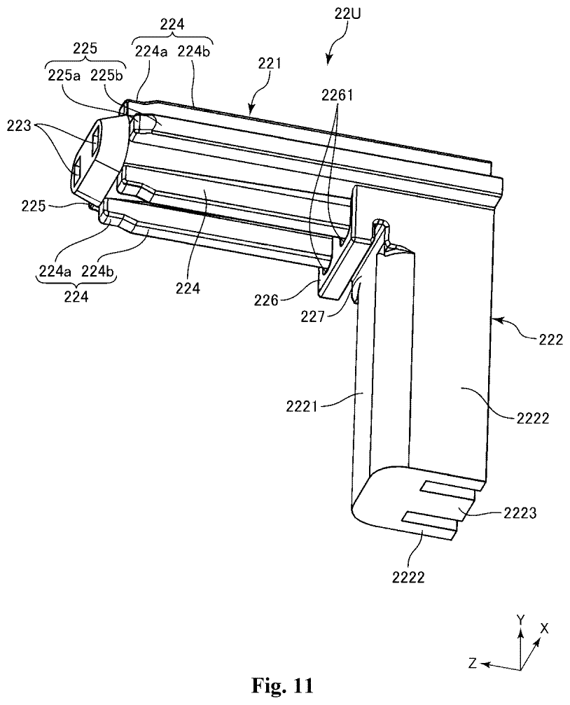

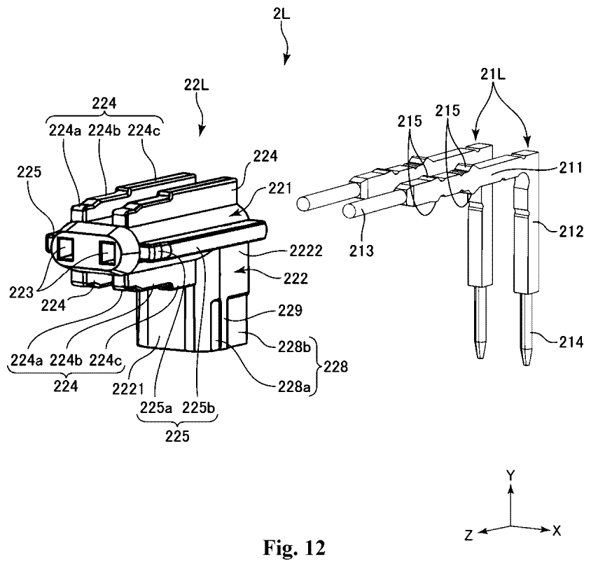

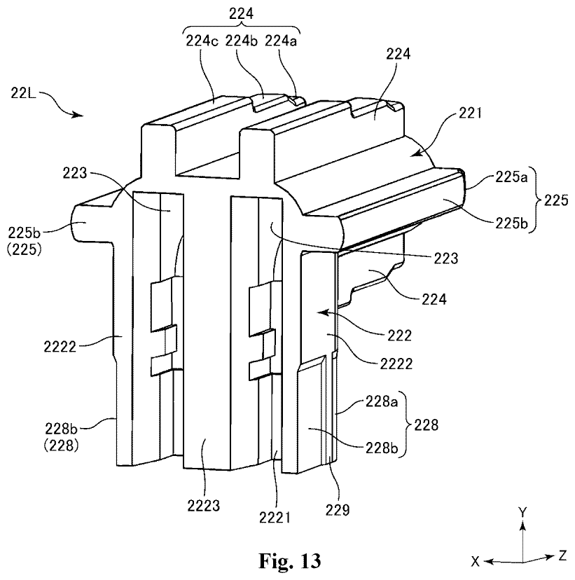

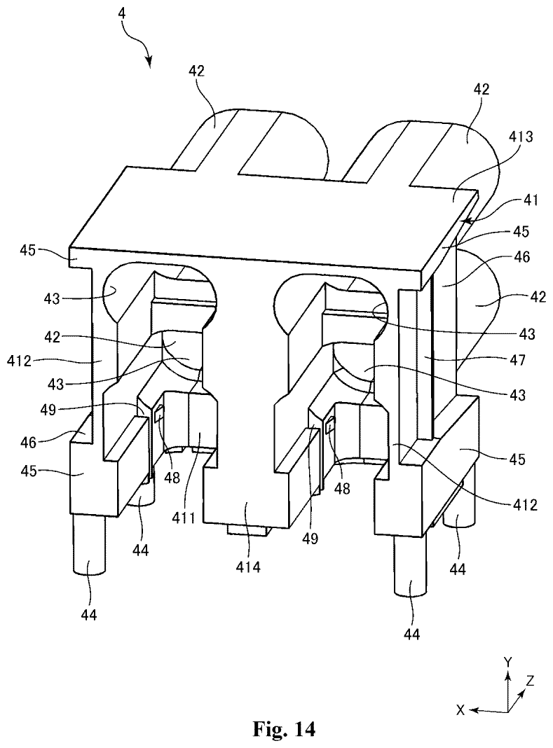

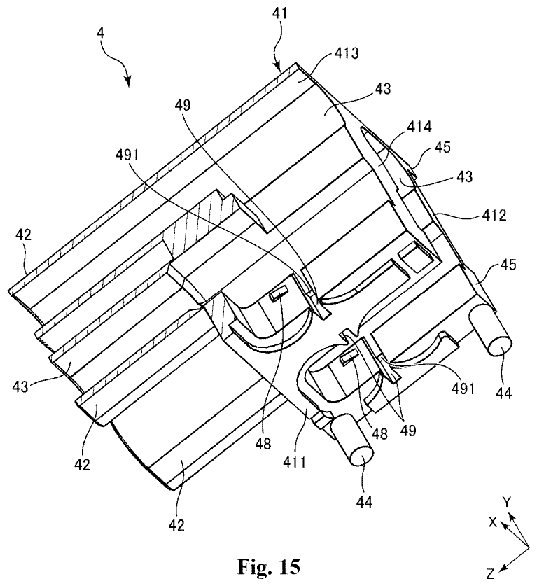

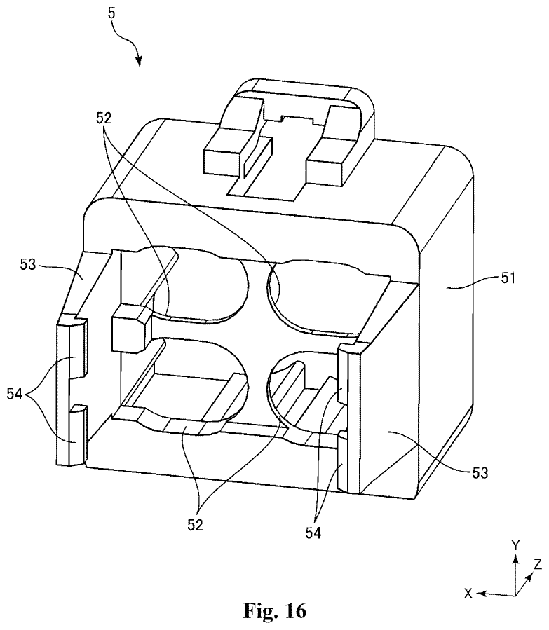

FIG. 5 is a perspective view showing an electrical connector of the present disclosure. FIG. 6 is a perspective view of the electrical connector of the present disclosure viewed from another angle. FIG. 7 is a cross-sectional view of the electric connector shown in FIG. 5 along a YZ plane including contact pins. FIG. 8 is a cross-sectional perspective view of the electric connector shown in FIG. 5 along the YZ plane including the contact pins. FIG. 9 is an exploded perspective view of the electrical connector shown in FIG. 5. FIG. 10 is an exploded perspective view of an upper receptacle assembly of the electrical connector shown in FIG. 5. FIG. 11 is a perspective view of a housing of the upper receptacle assembly shown in FIG. 10 viewed from another angle. FIG. 12 is an exploded perspective view of a lower receptacle assembly of the electrical connector shown in FIG. 5. FIG. 13 is a perspective view of a housing of the lower receptacle assembly shown in FIG. 12 viewed from another angle. FIG. 14 is a perspective view of a shell shown in FIG. 9 viewed from another angle. FIG. 15 is a cross-sectional perspective view of the shell shown in FIG. 9. FIG. 16 is a perspective view of a cover shown in FIG. 9 viewed from another angle.

An electrical connector 1 of the present disclosure is a receptacle connector to be mounted on a circuit board provided in an arbitrary device. When a mating connector (a plug connector) attached to tip end portions of four coaxial cables each having a pair of core wires is inserted into the electrical connector 1 from the tip side, the electrical connector 1 and the mating connector are coupled with each other. At this time, electrical connections between the four coaxial cables and the circuit board are provided through the electrical connector 1 and the mating connector.

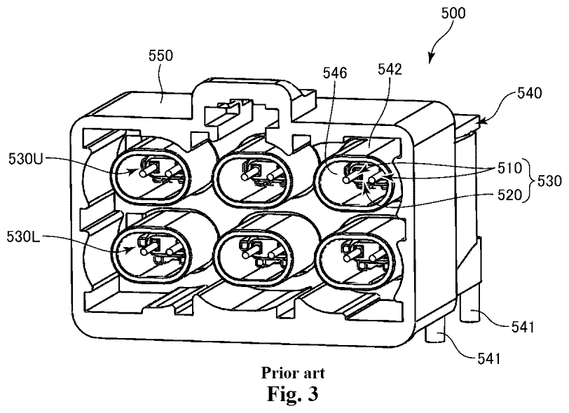

In the illustrated aspect, the electrical connector 1 includes two pairs of upper receptacle assemblies 2U and lower receptacle assemblies 2L. The upper receptable assemblies 2U are arranged so as to be respectively aligned with the lower receptacle assemblies 2L in the height direction of the electrical connector 1. However, the electrical connector 1 is not limited thereto. The electrical connector 1 may include at least one pair of the upper receptacle assembly 2U and the lower receptacle assembly 2L aligned in the height direction. For example, the electric connector 1 may include three pairs of the upper receptacle assemblies 2U and the lower receptacle assemblies 2L arranged in the width direction as shown in FIG. 3.

Further, although the electric connector 1 is configured so that each of the upper receptacle assemblies 2U includes a pair of upper contact pins 21U and each of the lower receptacle assemblies 2L includes a pair of lower contact pins 21L in the illustrated aspect, the present disclosure is not limited thereto. The scope of the present disclosure also involves an aspect in which each of the two upper receptacle assemblies 2U includes one, three or more upper contact pins 21U and each of the two lower receptacle assemblies 2L includes one, three or more lower contact pins 21L. Hereinafter, description will be given to the present disclosure with assuming that the electric connector 1 is an in-vehicle Ethernet multi-pin connector (8-pin connector) including the two pairs of the upper receptacle assemblies 2U and the lower receptacle assemblies 2L aligned in the width direction, each of the upper receptacle assemblies 2U includes the pair of upper contact pins 21U, and each of the lower receptacle assemblies 2L includes the pair of lower contact pins 21L.

As shown in FIGS. 5 to 9, in particular, in FIG. 9, the electrical connector 1 includes the two lower receptacle assemblies 2L, the two upper receptacle assemblies 2U respectively located on the upper side and the base side of the two lower receptacle assemblies 2L, two shield members 3 respectively located between the lower receptacle assemblies 2L and the upper receptacle assemblies 2U, a metal shell 4 for holding the two lower receptacle assemblies 2L, the two upper receptacle assemblies 2U, and the two shield members 3, and a cover 5 attached to a tip side portion of the shell 4 to guide coupling between the mating connector and the electrical connector 1.

The two lower receptacle assemblies 2L and the two upper receptacle assemblies 2U are members to be held by the shell 4 and respectively connected to corresponding plug assemblies of the mating connectors. As shown in FIGS. 7 and 8, one of the lower receptacle assemblies 2L and one of the upper receptacle assemblies 2U are paired and aligned in the height direction in a state that the two lower receptacle assemblies 2L and the two upper receptacle assemblies 2U are held by the shells 4. Similarly, the other one of the lower receptacle assemblies 2L and the other one of the upper receptacle assemblies 2U are paired and aligned in the height direction. Further, the upper receptacle assemblies 2U are held by the shells 4 so as to be respectively located on the upper side and the base side of the corresponding lower receptacle assemblies 2L.

Since the two upper receptacle assemblies 2U have the same configuration as each other, detailed description will be given to one of the upper receptacle assemblies 2U as a representative. As shown in FIG. 10, the upper receptacle assembly 2U includes the pair of upper contact pins 21U which should respectively contact with corresponding contact pins of the mating connector, and an insulating upper housing 22U for holding the pair of upper contact pins 21U.

Each of the upper contact pins 21U is an L-shaped member made of conductive material such as a copper-alloy. The upper contact pin 21U has a function of contacting with the corresponding contact pin of the mating connector when the electrical connector 1 and the mating connector are coupled with each other to provide an electrical connection between the mating connector and the electrical connector 1. Since each of the upper contact pins 21U has the same configuration as each other, detailed description will be given to the configuration of the upper contact pin 21U located on the +X direction side as a representative example.

The upper contact pin 21U includes a horizontally extending portion 211 linearly extending in the front-rear direction (the Z direction), a downwardly extending portion 212 linearly extending from a base end portion of the horizontally extending portion 211 toward the lower side, a contact portion 213 linearly extending from a tip end portion of the horizontally extending portion 211 toward the tip side, a terminal portion 214 linearly extending from a lower end portion of the downwardly extending portion 212 toward the lower side, and two pairs of protrusions 215 respectively extending from an upper surface and a lower surface of the horizontally extending portion 211 in the height direction (the Y direction or the outer side).

The horizontally extending portion 211 is a plate-shaped portion linearly extending in the front-rear direction. The downwardly extending portion 212 is a plate-shaped portion linearly extending from the base end portion of the horizontally extending portion 211 toward the lower side. As shown in FIGS. 7 and 8, when the upper contact pin 21U is press-fitted into a corresponding insertion hole 223 formed in a cylindrical portion 221 of the upper housing 22U, the horizontally extending portion 211 is located in the cylindrical portion 221 and the downwardly extending portion 212 is located in a downwardly extending portion 222 of the upper housing 22U.

Referring back to FIG. 10, the contact portion 213 is a columnar portion linearly extending from the tip end portion of the horizontally extending portion 211 toward the tip side. When the upper contact pin 21U is held by the upper housing 22U, the contact portion 213 protrudes from the cylindrical portion 221 of the upper housing 22U and is exposed to the outside. When the electrical connector 1 and the mating connector are coupled with each other, the contact portion 213 contacts with the corresponding contact pin of the mating connector to provide the electrical connection between the mating connector and the electrical connector 1.

The terminal portion 214 is a substantially pyramidal portion formed so as to protrude from the lower end portion of the downwardly extending portion 212 toward the lower side. When the upper contact pin 21U is held by the upper housing 22U, the terminal portion 214 extends from the downwardly extending portion 222 of the upper housing 22U toward the lower side and is exposed to the outside. The terminal portion 214 should be connected to a corresponding terminal of the circuit board on which the electrical connector 1 should be mounted.

The two pairs of protrusions 215 respectively protrude from the upper surface and the lower surface of the horizontally extending portion 211 in the height direction (the Y direction or the outer side). Two upper protrusions 215 protrude from the upper surface of the horizontally extending portion 211 in the +Y direction. Two lower protrusions 215 protrude from the lower surface of the horizontally extending portion 211 in the −Y direction. The upper protrusion 215 and the lower protrusion 215 of each pair are formed at positions facing each other through the horizontally extending portion 211. Each of the protrusions 215 has a function of increasing holding force for holding the upper contact pin 21U in the insertion hole 223 of the upper housing 22U due to its frictional force caused when each of the protrusions 215 is strongly pressed by an inner surface of the insertion hole 223 in a state that the upper contact pin 21U is press-fitted into the insertion hole 223.

Further, opposite surfaces of the horizontally extending portions 211 and the downwardly extending portions 212 of the pair of upper contact pins 21U (+X direction surfaces of the horizontally extending portion 211 and the downwardly extending portion 212 of the upper contact pin 21U located on the −X direction in FIG. 10 and −X direction surfaces of the horizontally extending portion 211 and the downwardly extending portion 212 of the upper contact pin 21U located on the +X direction in FIG. 10) are flat surfaces. With this configuration, it is possible to allow a separation distance between the opposite surfaces of the horizontally extending portions 211 and the downwardly extending portions 212 of the pair of upper contact pins 21U facing each other to be constant, and thereby improving transmission characteristics of signals, in particular, transmission characteristics of high-frequency signals transmitted through the pair of upper contact pins 21U.

The above-described upper contact pin 21U is press-fitted into the insertion hole 223 of the upper housing 22U and held by the upper housing 22U. The upper housing 22U is made of clastic insulating material such as resin material (for example, LCP (Liquid Crystal Polymer)). As shown in FIGS. 10 and 11, the upper housing 22U includes the cylindrical portion 221 extending in the front-rear direction (the Z direction) and the downwardly extending portion 222 extending from a base end portion of the cylindrical portion 221 toward the lower side.

The cylindrical portion 221 is a cylindrical portion linearly extending in the front-rear direction. The cylindrical portion 221 has a rectangular planar shape with rounded corners in a planar view viewed from the Z direction. In the planar view viewed from the Z direction, a length of the cylindrical portion 221 in the width direction (the X direction) is longer than a length in the height direction (the Y direction). An upper surface and a lower surface of the cylindrical portion 221 are flat surfaces spaced apart from each other and extending in the front-rear direction. Further, both side surfaces of the cylindrical portion 221 in the X direction are curved surfaces spaced apart from each other and extending in the front-rear direction.

The cylindrical portion 221 includes the pair of insertion holes 223 passing through the cylindrical portion 221 in the front-rear direction, four first pressing ribs 224 located on the upper surface and the lower surface of the cylindrical portion 221 and extending in the front-rear direction, a pair of second pressing ribs 225 respectively located on both X-direction side surfaces of the cylindrical portion 221 and extending in the front-rear direction, a block portion 226 provided on the lower surface of the cylindrical portion 221 so as to protrude toward the lower side, and an engagement recess 227 formed on the block portion 226 so as to be opened toward the lower side.

The pair of insertion holes 223 are aligned in the width direction so as to be parallel to each other and linearly extend in the front-rear direction with being spaced apart from each other. Each of the insertion holes 223 passes through the cylindrical portion 221 in the front-rear direction. The pair of upper contact pins 21U are respectively press-fitted into the pair of insertion holes 223. The insertion hole 223 has a shape corresponding to a shape of the horizontally extending portion 211 of the upper contact pin 21U. The insertion hole 223 has a substantially rectangular planar shape in the planar view viewed from the Z direction.

Each of the four first pressing ribs 224 includes a low height portion 224a located at a tip side portion of the cylindrical portion 221 and a middle height portion 224b extending from a base end portion of the low height portion 224a toward the base side. The low height portion 224a is a protrusion located on the tip side portion of the cylindrical portion 221 and extending from the tip portion of the cylindrical portion 221 toward the base side with keeping a constant height. As shown in FIG. 7, the height (a length in the Y direction) of the low height portion 224a is set so that the low height portion 224a does not contact with an inner peripheral surface of the insertion hole 43 of the shell 4 in the state the upper housing 22U is held by the shell 4.

Referring back to FIGS. 10 and 11, the middle height portion 224b is located on the base side of the low height portion 224a. A tip side portion of the middle height portion 224b is an inclined portion whose height gradually increases from the tip side toward the base side. A tip end surface of the middle height portion 224b is an inclined surface inclined from the inner side toward the outer side as it extends from the tip side toward the base side. A tip end portion of the tip end surface is continuous with the base end portion of the low height portion 224a. A portion other than the tip side portion of the middle height portion 224b is a protrusion extending toward the base side with keeping a constant height. The height (a protruding amount in the Y direction) of the middle height portion 224b is higher than the height of the low height portion 224a. As shown in FIG. 7, the height (the length in the Y direction) of the middle height portion 224b is set so that an outer surface (a surface perpendicular to the Y direction) of the middle height portion 224b contacts with the inner peripheral surface of the insertion hole 43 of the shell 4 in the state the upper housing 22U is held by the shell 4. In addition, base end portions of the middle height portions 224b of the two first pressing ribs 224 formed on the lower surface of the cylindrical portion 221 are connected to a tip end surface of the block portion 226.

In a natural state that any external force is not applied to the upper housing 22U, a total length of an outer diameter of the cylindrical portion 221 in the height direction (the Y direction) and the heights (the protruding amounts) of the pair of upper and lower middle height portions 224b is slightly larger than an inner diameter of the insertion hole 43 of the shell 4 in the Y direction. With this configuration, the outer surfaces of the middle height portions 224b contact with the inner peripheral surface of the insertion hole 43 and are pressed toward the inner side when the cylindrical portion 221 is inserted into the insertion hole 43. As a result, the upper housing 22U is held by the shell 4. Further, since the upper housing 22U is made of the elastic insulating material, the cylindrical portion 221 can be elastically deformed toward the inner side. Thus, when the upper housing 22U is inserted into the insertion hole 43, the outer surfaces of the middle height portions 224b of the four first pressing ribs 224 are pressed toward the inner side by the inner peripheral surface of the insertion hole 43. As a result, portions of the cylindrical portion 221 where the middle height portions 224b are formed are elastically deformed toward the inner side. As a result, it is possible to allow the inner surface of the insertion hole 223 of the upper housing 22U to more strongly contact with the protrusions 215 of the upper contact pin 21U, and thereby preventing the upper contact pin 21U from being shifted in the insertion hole 223 and removed from the insertion hole 223.

The pair of second pressing ribs 225 are formed in order to prevent the upper contact pin 21U from being shifted toward the base side in the insertion hole 223 of the upper housing 22U or removed from the insertion hole 223 and to prevent the cylindrical portion 221 of the upper housing 22U from removed from the insertion hole 223 in the state that the cylindrical portion 221 is inserted into the insertion hole 43 of the shell 4. The pair of second pressing ribs 225 are protrusions linearly extending in the front-rear direction with being spaced apart from each other. The pair of second pressing ribs 225 face each other at an angular interval of 180 degrees through the pair of insertion holes 223. The pair of second pressing ribs 225 are respectively formed on both side surfaces (both side surfaces in the X direction) of the cylindrical portion 221.

Each of the second pressing ribs 225 includes a low height portion 225a located at the tip side portion of the cylindrical portion 221 and a high height portion 225b extending from a base end portion of the low height portion 225a toward the base side. The low height portion 225a is a protrusion located at the tip side portion of the cylindrical portion 221 and extending with keeping a constant height from its tip end portion toward the base side. A height (a length in the X direction) of the low height portion 225a is set so that the low height portion 225a does not contact with the inner peripheral surface of the insertion hole 43 of the shell 4 in the state that the upper housing 22U is held by the shell 4.

The high height portion 225b is located on the base side of the low height portion 225a. A tip side portion of the high height portion 225b is an inclined portion whose height gradually increases from the tip side toward the base side. A tip end surface of the high height portion 225b is an inclined surface which inclines from the inner side toward the outer side as it extends from the tip side toward the base side. A tip end portion of the tip end surface is continuous with the base end portion of the low height portion 225a. A portion other than the tip side portion of the high height portion 225b is a protrusion extending toward the base side with keeping a constant height. A height (a protruding amount in the X direction) of the high height portion 225b is higher than a height of the low height portion 225a.

The high height portion 225b is provided so as to contact with the inner peripheral surface of the insertion hole 43 of the shell 4 in the state that the upper housing 22U is held by the shell 4 for preventing the cylindrical portion 221 of the upper housing 22U from being removed from the insertion hole 223. Further, in the natural state that the external force is not applied to the upper housing 22U, a total length of an outer diameter of the cylindrical portion 221 in the width direction (the X direction) and the heights (the protruding amounts) of the pair of high height portions 225b is slightly larger than the inner diameter of the insertion hole 43 of the shell 4 in the width direction. With this configuration, outer surfaces of the high height portions 225b contact with the inner peripheral surface of the insertion hole 43 and are pressed toward the inner side when the cylindrical portion 221 is inserted into the insertion hole 43. As a result, the upper housing 22U is held by the shell 4. Further, the cylindrical portion 221 can be elastically deformed toward the inner side as described above. Thus, the outer surfaces of the high height portions 225b contact with the inner peripheral surface of the insertion hole 223 and are pressed toward the inner side when the upper housing 22U is inserted into the insertion hole 43, and thereby portions of the cylindrical portion 221 where the high height portions 225b are formed are elastically deformed toward the inner side. With this configuration, it is possible to allow the inner surface of the insertion hole 223 of the upper housing 22U to more strongly contact with the upper contact pin 21U, and thereby it is possible to prevent the upper contact pin 21U from being shifted in the insertion hole 223 and being removed from the insertion hole 223.

The block portion 226 is a block-like portion formed on the lower surface of the cylindrical portion 221 so as to protrude from a base end portion of the cylindrical portion 221 adjacent to the downwardly extending portion 222 toward the lower side. The tip end surface of the block portion 226 is connected to the base end portions of the middle height portions 224b of the two first pressing ribs 224 formed on the lower surface of the cylindrical portion 221. Further, a base end surface of the block portion 226 is connected to the downwardly extending portion 222. The tip end surface of the block portion 226 is a flat surface perpendicular to the front-rear direction and a lower surface of the block portion 226 is a flat surface perpendicular to the height direction. Further, recesses 2261 are formed on the tip end surface of the block portion 226 and at portions adjacent to the base end portions of the middle height portions 224b of the two first pressing ribs 224 for allowing a lower end portion of the block portion 226 to be elastically deformed (bent) in the front-rear direction.

The engagement recess 227 is a rectangular recess formed on the lower surface of the block portion 226 so as to be opened toward the lower side. As shown in FIG. 11, the engagement recess 227 linearly extends in the width direction (the X direction) on the lower surface of the block portion 226. Both end portions of the engagement recess 227 in the width direction are not closed and opened toward the outside. A width of the engagement recess 227 in the Z direction is substantially equal to a thickness of the shield member 3. A tip side inner surface and a base side inner surface of the engagement recess 227 are flat surfaces perpendicular to the front-rear direction. Further, an upper inner surface of the engagement recess 227 is a flat surface perpendicular to the height direction.

As shown in FIGS. 7 and 8, an upper end portion of an insertion portion 33 (see FIG. 9) of the shield member 3 is inserted into the engagement recess 227 in a state that the electrical connector 1 is assembled. In this state, the insertion portion 33 contacts with the tip side inner surface and the base side inner surface of the engagement recess 227. On the other hand, the insertion portion 33 does not contact with the upper inner surface of the engagement recess 227 and faces the upper inner surface of the engagement recess 227 through a gap therebetween. As described later, the shield member 3 is press-fitted into a slit 49 of the shell 4 and fixed with respect to the shell 4, and thereby the shield member 3 cannot be moved in the front-rear direction. Thus, by inserting the shield member 3 into the engagement recess 227 and engaging the cylindrical portion 221 of the upper housing 22U with the shield member 3, it is possible to reliably prevent the upper housing 22U from being shifted in the shell 4 toward the base side. With this configuration, it is possible to prevent the upper receptacle assembly 2U from being shifted in the shell 4 and stabilize a position of the upper contact pin 21U in the shell 4, thereby improving the contact reliability of the electric connector 1.

Returning back to FIGS. 10 and 11, the downwardly extending portion 222 is provided for containing the downwardly extending portion 212 of the upper contact pin 21U therein when the upper contact pin 21U is held by the upper housing 22U. The downwardly extending portion 222 includes a front plate 2221 extending from a lower portion of the base end portion of the cylindrical portion 221 toward the lower side, a pair of side wall portions 2222 extending from both width-direction (X direction) end portions of the front plate 2221 toward the base side, and a center wall portion 2223 extending from a center of the front plate 2221 in the width direction between the pair of side wall portions 2222 toward the base end side with being spaced apart from the pair of side wall portions 2222.

The front plate 2221 is a plate-like portion vertically extending from the lower portion of the base end portion of the cylindrical portion 221 toward the lower side. The pair of side wall portions 2222 are plate-like portions respectively extending from both width-direction (X-direction) end portions of the front plate 2221 toward the base side. Two inner spaces for respectively containing the downwardly extending portions 212 of the pair of upper contact pins 21U are defined by a base end surface of the front plate 2221, inner surfaces of the pair of side wall portions 2222, and outer surfaces of the center wall portion 2223. As shown in FIGS. 7 and 8, the downwardly extending portions 212 of the pair of upper contact pins 21U are respectively located in the two inner spaces of the downwardly extending portion 222 when the pair of upper contact pins 21U are held by the upper housing 22U. The center wall portion 2223 is a plate-like portion extending from the center of the front plate 2221 in the width direction (the X direction) toward the base side. The center wall portion 2223 is located between the pair of side wall portions 2222 and faces both of the side wall portions 2222 through gaps therebetween. The center wall portion 2223 partitions the above-described two inner spaces.

Next, referring to FIGS. 12 and 13, detailed description will be given to the two lower receptacle assemblies 2L. Since the two lower receptacle assemblies 2L have the same configuration as each other, detailed description will be given to one of the lower receptacle assemblies 2L as a representative example. As shown in FIG. 12, the lower receptacle assembly 2L includes a pair of lower contact pins 21L which should respectively contact with corresponding contact pins of the mating connector, and an insulating lower housing 22L for holding the pair of lower contact pins 21L.

Each of the lower contact pins 21L has the same configuration as the above-described configuration of the upper contact pin 21U except that lengths of the horizontally extending portion 211 and the downwardly extending portion 212 are shortened. Thus, the above description for the upper contact pin 21U is also applied to each of the lower contact pins 21L

Similarly to the pair of upper contact pins 21U, opposite surfaces of the horizontally extending portions 211 and the downwardly extending portions 212 of the pair of lower contact pins 21L (+X direction side surfaces of the horizontally extending portion 211 and the downwardly extending portion 212 of the lower contact pin 21L located on the −X direction side in FIG. 12 and −X direction side surface of the downwardly extending portion 212 and the horizontally extending portion 211 and −X direction side surfaces of the horizontally extending portion 211 and the downwardly extending portion 212 of the lower contact pin 21L located on +X direction side in FIG. 12) are flat surfaces. With this configuration, it is possible to allow a separation distance between the opposite surfaces of the horizontally extending portions 211 and the downwardly extending portions 212 of the pair of lower contact pins 21L facing each other to be constant, thereby improving transmission characteristics of signals, in particular, transmission characteristics of high-frequency signals transmitted through the pair of lower contact pins 21L.

The lower housing 22L has the same configuration as the above-described configuration of the upper housing 22U except that lengths of the cylindrical portion 221 and the downwardly extending portion 222 are shortened, each of the four first pressing ribs 224 further includes a high height portion 224c, the downwardly extending portion 222 further includes cutout portions 228 and engagement protrusions 229, and the block portion 226 and the engagement recess 227 are omitted. Thus, detailed description will be given to the differences between the lower housing 22L and the upper housing 22U and description for the common points between the upper housing 22U of the lower housing 22L will be omitted.

Each of the four first pressing ribs 224 of the lower housing 22L further includes the high height portion 224c. The high height portion 224c is located on the base side of the middle height portion 224b and extending from a base end portion of the middle height portion 224b toward the base side with keeping a constant height so as to protrude toward the outer side. A lower end portion of a tip side portion of the high height portion 224c is continuous with the base end portion of the middle height portion 224b. As shown in FIGS. 7 and 8, a height (a length in the Y direction) of the high height portion 224c is set so that an outer surface (a surface perpendicular to the Y direction) of the high height portion 224c does not contact with the inner surface of the body portion 41 of the shell 4 when the lower housing 22L is held by the shell 4. In addition, base end portions of the high height portion 224c of the two first pressing ribs 224 formed on the lower surface of the cylindrical portion 221 are connected to the tip end surface of the front plate 2221 of the downwardly extending portion 222.

Referring back to FIGS. 12 and 13, the downwardly extending portion 222 of the lower housing 22L further includes the cutout portions 228 and the engagement protrusions 229 which are respectively formed on the outer surfaces of the pair of side wall portions 2222. The cutout portions 228 are concave portions respectively formed on lower portions of the outer side surfaces of the pair of the side wall portions 2222 along the front-rear direction. Each of the cutout portions 228 extends from a substantially center portion in the height direction toward a lower end portion of the side wall portion 2222 and extends from a tip end portion to a base end portion of the side wall portion 2222. The cutout portion 228 includes a first recess 228a formed on a tip side portion of the cutout portion 228 and a second recess 228b formed on the base side of the first recess 228a. The first recess 228a and the second recess 228b are partitioned by the engagement protrusion 229.

The engagement protrusion 229 is a protrusion formed on the outer surface of the cutout portion 228 of each of the side wall portions 2222 and between the first recess 228a and the second recess 228b. The engagement protrusion 229 is elongated in the height direction (the Y direction). The engagement protrusion 229 has a function of engaging with an engagement protrusion 48 (see FIGS. 14 and 15) formed on an inner surface of the body portion 41 of the shell 4 to lock the lower housing 22L in the shell 4. The engagement protrusion 229 linearly extends from an upper end portion to a lower end portion of the cutout portion 228 in the height direction. When the cylindrical portion 221 of the lower housing 22L is inserted into the insertion hole 43 of the shell 4, the engagement protrusion 48 is located in the second recess 228b and engaged with the engagement protrusion 229. With this configuration, it is possible to prevent the lower receptacle assembly 2L from being shifted in the shell 4 to stabilize a position of the lower contact pin 21L in the shell 4, thereby improving the contact reliability of the electrical connector 1.

Referring back to FIG. 9, each of the two shield members 3 has a function of preventing electromagnetic interference between the lower contact pin 21L and the upper contact pin 21U adjacent to each other in the front-rear direction. The two shield members 3 are respectively press-fitted into the slits 49 of the shell 4 from the lower side of the shell 4. By preventing the electromagnetic interference between the lower contact pin 21L and the upper contact pin 21U adjacent to each other in the front-rear direction, it is possible to improve the signal transmission characteristics of the electric connector 1.

As shown in FIGS. 7 and 8, the shield member 3 is a plate-like member made of metallic material and press-fitted into the slit 49. The shield member 3 is held by the shell 4 so as to be located between the downwardly extending portion 212 of the lower contact pin 21L and the downwardly extending portion 212 of the upper contact pin 21U. As shown in FIG. 9, the shield member 3 includes a plate-like body portion 31, a pair of positioning protrusions 32, and an insertion portion 33.

The body portion 31 is a plate-like portion extending in the XY plane. The pair of positioning protrusions 32 are respectively formed at lower end portions of both X-direction side surfaces of the body portion 31 so as to protrude toward the outer side. When the shield member 3 is press-fitted into the slit 49 of the shell 4, the pair of positioning protrusions 32 respectively abut against a pair of stopper portions 491 (see FIG. 15) formed in the slit 49, thereby performing positioning of the shield member 3 in the slit 49. The insertion portion 33 is formed on an upper end surface of the body portion 31 so as to protrude toward the upper side. As shown in FIGS. 7 and 8, when the shield member 3 is press-fitted into the slit 49 of the shell 4, an upper end portion of the insertion portion 33 is inserted into the engagement recess 227 of the upper housing 22U. At this time, the insertion portion 33 contacts and engages with the tip side inner surface and the base side inner surface of the engagement recess 227. As a result, the shield member 3 and the cylindrical portion 221 of the upper housing 22U are engaged with each other. This engagement can prevent the upper receptacle assembly 2U from being shifted in the shell 4 to stabilize the position of the upper contact pin 21U in the shell 4, thereby improving the contact reliability of the electric connector 1.

Further, as shown in FIG. 7, when the shield member 3 is press-fitted into the slit 49 of the shell 4, a separation distance from an upper end surface of the insertion portion 33 to a lower surface of the horizontally extending portion 211 of the upper contact pin 21U is equal to a separation distance from the inner surface of the cylindrical portion 42 of the shell 4 to the lower surface of the horizontally extending portion 211 of the upper contact pin 21U. With this configuration, it is possible to allow the distances from the lower surface of the horizontally extending portion 211 of the upper contact pin 21U to the conductive members (the shell 4 and the shield member 3) to be constant, thereby improving the signal transmission characteristics of the electric connector 1.

Although the electrical connector 1 includes the two shield members 3 in the illustrated aspect, the present disclosure is not limited thereto. The scope of the present disclosure also involves an aspect in which one shield member 3 is configured to be elongated in the width direction so as to face the downwardly extending portions 212 of the lower contact pins 21L of the two lower receptacle assemblies 2L arranged in the width direction (lateral direction) side by side and the downwardly extending portions 212 of the upper contact pins 21U of the two upper receptacle assemblies 2U arranged in the width direction side by side. In this aspect, the shield member 3 is a single plate-like member and located between the downwardly extending portions 212 of the lower contact pins 21L of the two lower receptacle assemblies 2L and the downwardly extending portions 212 of the upper contact pins 21U of the two upper receptacle assemblies 2U to prevent the electromagnetic interference between the two pairs of the lower contact pins 21L and the upper contact pin 21U adjacent to each other in the front-rear direction. With this configuration, it is possible to improve the signal transmission characteristics of the electric connector 1. In this case, a shape of the slit 49 of the shell 4 is appropriately changed according to a width of the shield member 3.

Referring back to FIG. 9, the shell 4 has a function as a housing for containing each component of the electrical connector 1 therein and a function as an electrical path for electrically connecting between the electrical connector 1 and the ground terminals on the circuit board on which the electrical connector 1 should be mounted. As shown in FIGS. 14 and 15, the shell 4 is a box-like member made of metallic material.

The shell 4 includes a body portion 41 constituted of a front plate 411, a pair of side walls 412, a top plate 413, and a center wall portion 414, four cylindrical portions 42 extending from a tip end surface of the front plate 411 of the body portion 41 toward the tip side, four insertion holes 43 through each of which the upper housing 22U or the lower housing 22L is passed, four ground terminals 44 extending from a lower end portion of the body portion 41 toward the lower side, a pair of wall portions 45 formed on each of the side walls 412 of the body portion 41 so as to be spaced apart from each other in the Z direction, a cover receiving portion 46 formed on an outer surface of each of the side walls 412, an engagement wall 47 extending in the height direction in each of the cover receiving portions 46, the four engagement protrusions 48 respectively protruding from inner surfaces of the pair of side walls 412 and both side surfaces of the center wall portion 414, and the two slits 49 formed on a lower surface of the body portion 41.

The body portion 41 includes the front plate 411, the pair of side walls 412 extending from width-direction end portions of the front plate 411 toward the base side, the top plate 413 extending from an upper end portion of the front plate 411 toward the base side, and the center wall portion 414 located between the pair of side walls 412. The body portion 41 has a box-like shape opened toward the base side and the lower side. Two containing spaces are formed by the inner side surfaces of the pair of side walls 412 and both side surfaces of the center wall portion 414. The pair of the lower receptacle assembly 2L and the upper receptacle assembly 2U are contained in one containing space. As shown in FIGS. 7 and 8, in the containing space, the horizontally extending portion 211 of the upper housing 22U is located on the upper side of the horizontally extending portion 211 of the lower housing 22L and the downwardly extending portion 212 of the upper housing 22U is located on the base side of the downwardly extending portion 212 of the lower housing 22L.

Referring back to FIGS. 14 and 15, the four cylindrical portions 42 are cylindrical portions formed on the tip end surface of the front plate 411 of the body portion 41 so as to protrude toward the tip side and form a 2×2 matrix. Each of the cylindrical portions 42 functions as an outer conductor covering the cylindrical portion 221 of the upper housing 22U or the lower housing 22L from the outer side. Further, when the mating connector and the electrical connector 1 are coupled with each other, the cylindrical portions 42 respectively contact with the corresponding outer contacts of the mating connector to allow the ground potential of the electrical connector 1 to be equal to the ground potential of the mating connector.

The four insertion holes 43 are elliptical through-holes formed so as to linearly extend in the front-rear direction. The cylindrical portion 221 of the upper housing 22U or the lower housing 22L is inserted into the insertion hole 43. Each of the two insertion holes 43 located on the upper side is formed so as to pass through the body portion 41 and the cylindrical portion 42 located on the upper side in the front-rear direction. In addition, lower portions of the two insertion holes 43 located on the upper side are cut so as to be opened toward the lower side in the body portion 41. On the other hand, each of the two insertion holes 43 located on the lower side is formed so as to pass through the cylindrical portion 42 located on the lower side in the front-rear direction. A width (a length in the X direction) of an inner diameter of each insertion hole 43 is larger than a height (a length in the Y direction) of the inner diameter of each insertion hole 43. A shape of each insertion hole 43 corresponds to the rectangular planar shape with the rounded corners of the cylindrical portion 221 of the upper housing 22U or the lower housing 22L.

As shown in FIG. 7, the inner peripheral surface of the insertion hole 43 contacts with the outer surfaces of the middle height portions 224b of the four first pressing ribs 224 of the upper housing 22U or the lower housing 22L when the cylindrical portion 221 of the upper housing 22U or the lower housing 22L is inserted into the insertion hole 43. As a result, the outer side surfaces of the middle height portions 224b of the four first pressing ribs 224 are pressed toward the inner side, and thereby the portions of the cylindrical portion 221 on which the middle height portions 224b are formed are elastically deformed toward the inner side. Further, the outer surfaces of the high height portions 225b of the pair of second pressing ribs 225 of the upper housing 22U or the lower housing 22L are pressed toward the inner side by the inner peripheral surface of the insertion hole 43 when the cylindrical portion 221 of the upper housing 22U or the lower housing 22L is inserted into the insertion hole 43, and thereby the portions of the cylindrical portion 221 on which the high height portions 225b are formed are elastically deformed toward the inner side. Due to these elastic deformations of the cylindrical portion 221 toward the inner side, it is possible to lock the upper contact pin 21U or the lower contact pin 21L in the insertion hole 223 of the upper housing 22U or the lower housing 22L.

Referring back to FIGS. 14 and 15, the four ground terminals 44 are respectively connected to the corresponding ground terminals of the circuit board on which the electrical connector 1 should be mounted. The shell 4 is electrically connected to the ground terminals of the circuit board through the ground terminals 44, and thereby it is possible to allow the ground potential of the electrical connector 1 to be equal to the ground potential of the circuit board.

The pair of wall portions 45 are provided on each of the side walls 412 of the body portion 41 in order to form the pair of cover receiving portions 46 for respectively receiving a pair of protruding pieces 53 (see FIG. 16) of the cover 5. One of the wall portions 45 is formed on an upper side portion (+Y direction side portion) of each of the side walls 412. The other one of the wall portions 45 is formed on a lower side portion (−Y direction side portion) of each of the side walls 412. The pair of wall portions 45 face each other through the cover receiving portion 46. Inner surfaces (inner surfaces in the Y direction) of the pair of wall portions 45 are connected to each other by the engagement wall 47.

Each of the cover receiving portions 46 is formed on the outer surface of each of the side walls 412 of the body portion 41 so as to be located between the pair of wall portions 45. The cover receiving portions 46 have a function of respectively receiving the pair of protruding pieces 53 of the cover 5. The cover receiving portion 46 is defined by the outer surface of the side wall 412 of the body portion 41 and the inner surface of the pair of wall portions 45. The engagement wall 47 is formed in the cover receiving portion 46 so as to extend in the height direction for enabling the attachment of the cover 5 with respect to the shell 4.

The four engagement protrusions 48 are protrusions respectively formed on the inner surfaces of the pair of side walls 412 and both side surfaces of the center wall portion 414 so as to respectively face the pair of side wall portions 2222 of the downwardly extending portions 222 of the lower housing 22L so as to protrude toward the inner side. The engagement protrusions 48 are respectively formed at positions for allowing each engagement protrusion 48 to engage with the engagement protrusion 229 of the downwardly extending portion 222 of the lower housing 22L when the cylindrical portion 221 of the lower housing 22L is inserted into the insertion holes 43 of the shell 4. The engagement protrusion 48 has a tapered shape whose width in the front-rear direction (the Z direction) gradually decreases as a distance from the inner surface of the side wall 412 or the side surface of the center wall portion 414 increases. When the cylindrical portion 42 of the lower housing 22L is inserted into the insertion hole 43, each of the engagement protrusions 48 engages with the corresponding engagement protrusion 229 with being located in the second recess 228b of the downwardly extending portion 222 of the lower housing 22L, thereby improving the holding force for the lower receptacle assembly 2L in the shell 4.

The two slits 49 are portions into which the two shield members 3 are respectively press-fitted. The two slits 49 are formed on the inner surfaces of the pair of side walls 412 and both side surfaces of the center wall portion 414 so as to extend from the lower surface of the body portion 41 toward the upper side. Each of the slits 49 is formed at a position for allowing the shield member 3 to be located between the downwardly extending portion 222 of the upper housing 22U and the downwardly extending portion 222 of the lower housing 22L when the shield member 3 is press-fitted into the slit 49. Further, the slit 49 is divided into left and right portions by the containing space of the body portion 41.

The slit 49 has the pair of stopper portions 491 protruding from opposite side surfaces (both side surfaces in the X direction) of the slit 49 toward the inner side. The pair of stopper portions 491 protrude in the slit 49 from the opposite side surfaces of the slit 49 toward the inner side. Thus, a depth of a portion of the slit 49 where the pair of stopper portions 491 are formed is shallower than a depth of other portions of the slit 49. A lower end surface of the stopper portion 491 is a flat surface perpendicular to the height direction. Thus, when the shield member 3 is press-fitted into the slit 49, upper surfaces of the pair of positioning protrusions 32 of the shield member 3 contact with the lower surfaces of the pair of stopper portions 491 in the slit 49, thereby performing the positioning of the shield member 3 in the slit 49.

Referring back to FIG. 9, the cover 5 is attached to the tip side portion of the shell 4 and has a function of guiding the coupling between the electrical connector 1 and the mating connector. As shown in FIG. 16, the cover 5 includes a rectangular cylindrical body portion 51, four insertion holes 52 formed on a base end surface of the body portion 51, the pair of protruding pieces 53 extending from the body portion 51 toward the base side, and a pair of engagement protrusions 54 extending from a base side edge portion of an inner surface of each of the protruding pieces 53 toward the inner side.

The body portion 51 has a bottomed rectangular cylindrical shape opened toward the tip side. When the mating connector is inserted into a tip side opening of the body portion 51, the coupling between the electrical connector 1 and the mating connector is guided. The four insertion holes 52 are formed on the base end surface of the body portion 51 to respectively pass the four cylindrical portions 42 of the shell 4 therethrough. The cover 5 is attached to the tip side portion of the shell 4 from the tip side so that the four cylindrical portions 42 of the shell 4 are respectively passed through the four insertion holes 52.

The pair of protruding pieces 53 are plate-like portions respectively extending from base end portions of a pair of opposed X-direction side surfaces (wall portions) of the body portion 51 toward the base side. The pair of protruding pieces 53 face each other through a gap therebetween. Each of the protruding pieces 53 has a shape corresponding to each of the above-described cover receiving portions 46 of the shell 4. When the cover 5 is attached to the shell 4, the pair of protruding pieces 53 are respectively contained in the pair of cover receiving portions 46.

The pair of engagement protrusions 54 are formed so as to engage with the engagement wall 47 formed on the shell 4 for enabling the attachment of the cover 5 with respect to the shell 4. Each of the engagement protrusions 54 is a tapered portion protruding from the base side edge portion of the inner surface of each of the protruding pieces 53 toward the inner side. A base end surface of the engagement protrusion 54 is an inclined surface and a tip side surface of the engagement protrusion 54 is a flat surface perpendicular to the front-rear direction.

When the cover 5 is attached to the shell 4, the pair of protruding pieces 53 of the cover 5 are respectively inserted into the pair of cover receiving portions 46 of the shell 4. When the cover 5 is pressed against the shell 4 in this state, the pair of engagement walls 47 of the shell 4 respectively slide on the base end surfaces of the pair of protruding pieces 53, and thereby the pair of protruding pieces 53 are opened toward the outer side. When the pair of protruding pieces 53 exceed over the pair of engagement walls 47, the pair of protruding pieces 53 are elastically recovered toward the inner side to respectively engage with the pair of engagement walls 47. With this snap fit, the cover 5 is fixed to the shell 4.

In the electric connector 1 of the present disclosure, the shield member 3 press-fitted into the slit 49 of the shell 4 is inserted into the engagement recess 227 of the cylindrical portion 221 of the upper housing 22U, and thereby the shield member 3 is engaged with the cylindrical portion 221 of the upper housing 22U as described above. With this configuration, the shield member 3 can prevent the upper receptacle assembly 2U from being shifted in the shell 4 as well as prevent the electromagnetic interference between the lower contact pin 21L and the upper contact pin 21U adjacent to each other in the front-rear direction. Further, in the electric connector 1 of the present disclosure, the engagement protrusions 229 of the lower housing 22L respectively engage with the engagement protrusions 48 of the shell 4. With this configuration, it is possible to prevent the lower receptacle assembly 2L from being shifted in the shell 4. Therefore, it is possible to stabilize the positions of the upper contact pin 21U and the lower contact pin 21L in the shell 4, thereby improving the contact reliability of the electric connector 1.

Further, in the electrical connector 1 of the present disclosure, the shield member 3 is located between the downwardly extending portion 222 of the lower contact pin 21L and the downwardly extending portion 222 of the upper contact pin 21U adjacent to each other in the front-rear direction. Thus, the shield member 3 can prevent the electromagnetic interference between the lower contact pin 21L and the upper contact pin 21U adjacent to each other in the front-rear direction, thereby improving the signal transmission characteristics of the electrical connector 1. Further, the opposite surfaces of the horizontally extending portions 211 and the downwardly extending portions 212 of the pair of upper contact pins 21U of each of the upper receptacle assemblies 2U are the flat surfaces. Similarly, the opposite surfaces of the horizontally extending portions 211 and the downwardly extending portions 212 of the pair of lower contact pins 21L of each of the lower receptacle assemblies 2L are the flat surfaces. With this configuration, it is possible to allow the separation distance between the opposite surfaces of the horizontally extending portions 211 and the downwardly extending portions 212 of the pair of upper contact pins 21U of each of the upper receptacle assemblies 2U and the separation distance between the opposite surfaces of the horizontally extending portions 211 and the downwardly extending portions 212 of the pair of lower contact pins 21L of each of the lower receptacle assemblies 2L to be constant, thereby improving the signal transmission characteristics, in particular, the high frequency signal transmission characteristics of the electrical connector 1. As described above, in the electrical connector 1 of the present disclosure, the signal transmission characteristics, in particular, the high frequency signal transmission characteristics of the electrical connector 1 can be remarkably improved by a synergistic effect of the configuration in which the electromagnetic interference is prevented by the shield member 3 and the configuration in which the separation distance between the opposite surfaces of the horizontally extending portions 211 and the downwardly extending portions 212 of the pair of upper contact pins 21U of each of the upper receptacle assemblies 2U and the separation distance between the opposite surfaces of the horizontally extending portions 211 and the downwardly extending portions 212 of the pair of lower contact pins 21L of each of the lower receptacle assemblies 2L are made constant.

Although the electrical connector of the present disclosure has been described with reference to the illustrated embodiment, the present disclosure is not limited thereto. Each configuration of the present disclosure can be replaced with an arbitrary configuration capable of performing the same function, or an arbitrary configuration can be added to each configuration of the present disclosure.

A person having ordinary skills in the art and the technique pertaining to the present disclosure may modify the configuration of the electrical connector of the present disclosure described above without meaningfully departing from the principle, the spirit and the scope of the present disclosure and the electrical connector having the modified configuration is also involved in the scope of the present disclosure.

In addition, the number and types of the components of the electrical connector shown in FIGS. 5 to 16 are merely illustrative examples and the present disclosure is not necessarily limited thereto. An aspect in which any component is added or combined or any component is omitted without departing from the principle and intent of the present disclosure is also involved within the scope of the present disclosure.

1. An electrical connector, comprising:
at least one lower receptacle assembly;
at least one upper receptacle assembly located on an upper side of the at least one lower receptacle assembly;
at least one shield member located between the at least one lower receptacle assembly and the at least one upper receptacle assembly; and
a metal shell for holding the at least one lower receptacle assembly, the at least one upper receptacle assembly, and the at least one shield member,
wherein each of the at least one lower receptacle assembly and the at least one upper receptacle assembly includes at least one contact pin and an insulating housing for holding the at least one contact pin therein,
wherein the at least one contact pin includes a horizontally extending portion linearly extending in a front-rear direction and a downwardly extending portion extending from a base end portion of the horizontally extending portion toward a lower side,
wherein the housing includes a cylindrical portion which linearly extends in the front-rear direction and in which the horizontally extending portion of the at least one contact pin is located, and a downwardly extending portion which extends from a base end portion of the cylindrical portion toward the lower side and in which the downwardly extending portion of the at least one contact pin is located,
wherein the at least one shield member is held by the shell so that the at least one shield member is located between the downwardly extending portion of the at least one contact pin of the at least one lower receptacle assembly and the downwardly extending portion of the at least one contact pin of the at least one upper receptacle assembly, and
wherein the at least one shield member engages with the cylindrical portion of the housing of the at least one upper receptacle assembly.

2. The electrical connector as claimed in claim 1, wherein the cylindrical portion of the housing of the at least one upper receptacle assembly has an engagement recess formed on an outer peripheral surface of the cylindrical portion so as to be opened toward the lower side, and
wherein the at least one shield member is inserted into the engagement recess, and thereby the at least one shield member and the cylindrical portion of the housing of the at least one upper receptacle assembly are engaged with each other.

3. The electrical connector as claimed in claim 2, wherein the at least one shield member includes a plate-like body portion and an insertion portion extending from an upper end surface of the body portion toward the upper side, and
wherein the insertion portion of the at least one shield member is inserted into the engagement recess and contacts with a tip side inner surface of the engagement recess.

4. The electrical connector as claimed in claim 2, wherein the at least one shield member has a plate-like shape, and
wherein the shell has at least one slit into which the at least one shield member is inserted from the lower side.

5. The electrical connector as claimed in claim 4, wherein the at least one shield member is press-fitted into the at least one slit of the shell.

6. The electrical connector as claimed in claim 4, wherein the at least one shield member has a plate-like body portion and a pair of positioning protrusions respectively extending from both side surfaces of the body portion toward an outer side,
wherein the at least one slit of the shell has a pair of stopper portions respectively protruding from both opposite side surfaces of the at least one slit toward an inner side, and
wherein upper surfaces of the pair of positioning protrusions of the at least one shield member respectively abut against lower surfaces of the pair of stopper portions of the at least one slit of the shell.

7. The electrical connector as claimed in claim 1, wherein the at least one lower receptable assembly contains two lower receptacle assemblies arranged in a lateral direction side by side,
wherein the at least one upper receptacle assembly contains two upper receptacle assemblies arranged in the lateral direction side by side,
wherein one of the two upper receptacle assemblies is located on the upper side of one of the two lower receptacle assemblies, and
wherein another one of the two upper receptacle assemblies is located on the upper side of another one of the two lower receptacle assemblies.

8. The electrical connector as claimed in claim 7, wherein the at least one shield member contains two shield members,
wherein one of the two shield members is held by the shell so as to be located between the downwardly extending portion of the at least one contact pin of the one of the two lower receptacle assemblies and the downwardly extending portion of the at least one contact pin of the one of the two upper receptacle assemblies, and
wherein another one of the two shield members is held by the shell so as to be located between the downwardly extending portion of the at least one contact pin of the other one of the two lower receptacle assemblies and the downwardly extending portion of the at least one contact pin of the other one of the two upper receptacle assemblies.

9. The electrical connector as claimed in claim 7, wherein the at least one shield member is a single plate-like member, and
wherein the shield member is configured to face the downwardly extending portions of the at least one contact pins of the two lower receptacle assemblies arranged in the lateral direction side by side and the downwardly extending portions of the at least one contact pins of the two upper receptacle assemblies arranged in the lateral direction side by side.
